(19) United States
(12) Patent Application Publication
(10) Pub. No.: US 2016/0140409 A1
(43) Pub. Date: May 19, 2016

(54) TEXT CLASSIFICATION BASED ON JOINT COMPLEXITY AND COMPRESSED SENSING

(71) Applicant: Dimitrios Milioris, Paris (FR)

(72) Inventor: Dimitrios Milioris, Paris (FR)

(73) Assignee: Alcatel Lucent, Boulogne-Billancourt (FR)

(21) Appl. No.: 14/540,770

(22) Filed: Nov. 13, 2014

(51) Int. Cl. G06K 9/18; G06T 11/20; G06K 9/46; G06F 17/30; G06K 9/62

(52) U.S. Cl. CPC G06K 9/18; G06F 17/3028; G06K 9/6267; G06K 9/4604; G06T 11/206

(57) ABSTRACT

A server computes a sparsifying matrix from a set of reference blocks that is selected from first blocks of text based on joint complexities of each pair of the first blocks of text. The server determines one of the set of reference blocks that is most similar to a second block of text based on the sparsifying matrix, a measurement matrix, and a measurement vector formed by compressing the second block of text using the measurement matrix. The server transmits a signal representative of the one of the set of reference blocks to indicate a classification of the second block of text.

### BACKGROUND

1. Field of the Disclosure

The present disclosure relates generally to communication systems and, more particularly, to classification of text blocks transmitted in communication systems.

2. Description of the Related Art

Networked “big data” applications such as Twitter continuously generate vast amounts of textual information in the form of strings of characters. For example, hundreds of millions of Twitter users produce millions of 140-character tweets every second. To be useful, the textual information should be organized into different topics or classes. Conventional text classification methods use machine learning techniques to classify blocks of textual information by comparing the textual information to dictionaries of keywords. These approaches are sometimes referred to as “bag of words” comparisons or “n-gram” comparisons. However, keyword-based classification by machine learning has a number of drawbacks. For example, classifying text blocks using keywords often fails because words in the text blocks may be used incorrectly or in a manner that differs from the conventional definition of the word. Keyword-based classification may also fail to account for implicit references to previous tweets, texts, or messages. Furthermore, keyword-based classification systems require construction of a different dictionary of keywords for each language. For another example, the machine learning techniques used in keyword-based classification may be computationally complex and are typically initiated manually by tuning model parameters used by the machine learning system. Consequently, machine learning techniques are not good candidates for real-time text classification. All of these drawbacks are exacerbated when classification is performed on high volumes of natural language texts, such as the millions of tweets per second generated by Twitter.

Blocks of text may also be classified by visiting network locations indicated by one or more uniform resource locators (URLs) associated with or included in the block of text. Information extracted from the network locations can then be used to classify the block of text. However, this approach has high overhead, at least in part because access to the information at one or more of the network locations may be blocked by limited access rights to the data, because of data size, or other reasons. A Hidden Markov Model may also be used to identify the (hidden) topics or classes of the blocks of text based on the observed words or characters in the block of text. However, Hidden Markov Models are computationally complex and difficult to implement. Classifying text using Hidden Markov Models therefore requires significant computational resources, which may make these approaches inappropriate for classifying the high volumes of natural language texts produced by applications such as Twitter.

### SUMMARY OF EMBODIMENTS

The following presents a summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In some embodiments, a method is provided for text classification based on joint complexity and compressive sensing. The method includes computing, at a first server, a sparsifying matrix from a set of reference blocks that is selected from first blocks of text based on joint complexities of each pair of the first blocks of text. The method also includes determining, at the first server, one of the set of reference blocks that is most similar to a second block of text based on the sparsifying matrix, a measurement matrix, and a measurement vector formed by compressing the second block of text using the measurement matrix. The method further includes transmitting, from the first server, a signal representative of the one of the set of reference blocks to indicate a classification of the second block of text.

In some embodiments, an apparatus is provided for text classification based on joint complexity and compressive sensing. The apparatus includes a processor to compute a sparsifying matrix from a set of reference blocks that is selected from first blocks of text based on joint complexities of each pair of the first blocks of text and determine one of the set of reference blocks that is most similar to a second block of text based on the sparsifying matrix, a measurement matrix, and a measurement vector formed by compressing the second block of text using the measurement matrix. The apparatus also includes a transceiver to transmit a signal representative of the one of the set of reference blocks to indicate a classification of the second block of text.

In some embodiments, an apparatus is provided for text classification based on joint complexity and compressive sensing. The apparatus includes a processor to form a measurement vector using a measurement matrix and a first block of text. The apparatus also includes a transceiver to transmit the measurement vector to a server and, in response, receive a signal representative of one of a set of reference blocks to indicate a classification of the first block of text. The set of reference blocks is selected from second blocks of text based on joint complexities of each pair of the second blocks of text. The one of the set of reference blocks is determined to be most similar to the first block of text based on a sparsifying matrix determined based on the set of reference blocks, the measurement matrix, and the measurement vector.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of an example of a communication system according to some embodiments.

FIG. 2 is a block diagram illustrating a dataset of text blocks in different time intervals according to some embodiments.

FIG. 3 is a diagram of a suffix tree for a text block according to some embodiments.

FIG. 4 is a diagram of a fully-connected graph representing text blocks in a time interval and a matrix of edge weights within the graph according to some embodiments.

FIG. 5 is a flow diagram of a method for identifying a set of reference text blocks that indicate corresponding classes according to some embodiments.

FIG. 6 is a flow diagram of a method for a pre-processing phase of classification of text blocks by compressive sensing according to some embodiments.

FIG. 7 is a flow diagram of a method for a runtime phase of classification of text blocks by compressive sensing according to some embodiments.

FIG. 8 is a flow diagram of a method for generating a tracking model and predicting classes of text blocks according to some embodiments.

FIG. 9 is a block diagram of an example of a communication system according to some embodiments.

### DETAILED DESCRIPTION

Blocks of text (such as tweets) transmitted over a network by different users can be classified in real time by selecting a set of reference blocks from blocks of text transmitted over the network during a time interval based on joint complexities of each pair of the blocks of text. The joint complexity of two blocks of text is the cardinality of a set including factors (or subsequences of characters) that are common to suffix trees that represent the two blocks of text. Blocks of text received over the network in subsequent time intervals are then classified by associating each block of text with a reference block that is most similar to the block of text. In some embodiments, the most similar reference block is determined by compressive sensing. For example, the block of text may be compressed using a measurement matrix to produce a measurement vector. A sparsifying matrix is constructed using the set of reference blocks and the most similar reference block is identified by optimizing a measurement model defined by the measurement vector, the measurement matrix, and the sparsifying matrix. In some embodiments, a model of the time evolution of the classes associated with blocks of text generated by an individual user may be created based on the previously classified blocks of text associated with the user, e.g., using Kalman filtering. The model may then be used to predict classes of blocks of texts generated by the user in future time intervals. Some embodiments of this classification technique may be implemented in a server that receives the measurement vectors corresponding to the blocks of text from one or more mobile devices. Exchanging compressed measurement vectors between the mobile devices and the server may conserve the limited memory and bandwidth available for communication over the air interface between the mobile devices and the server.

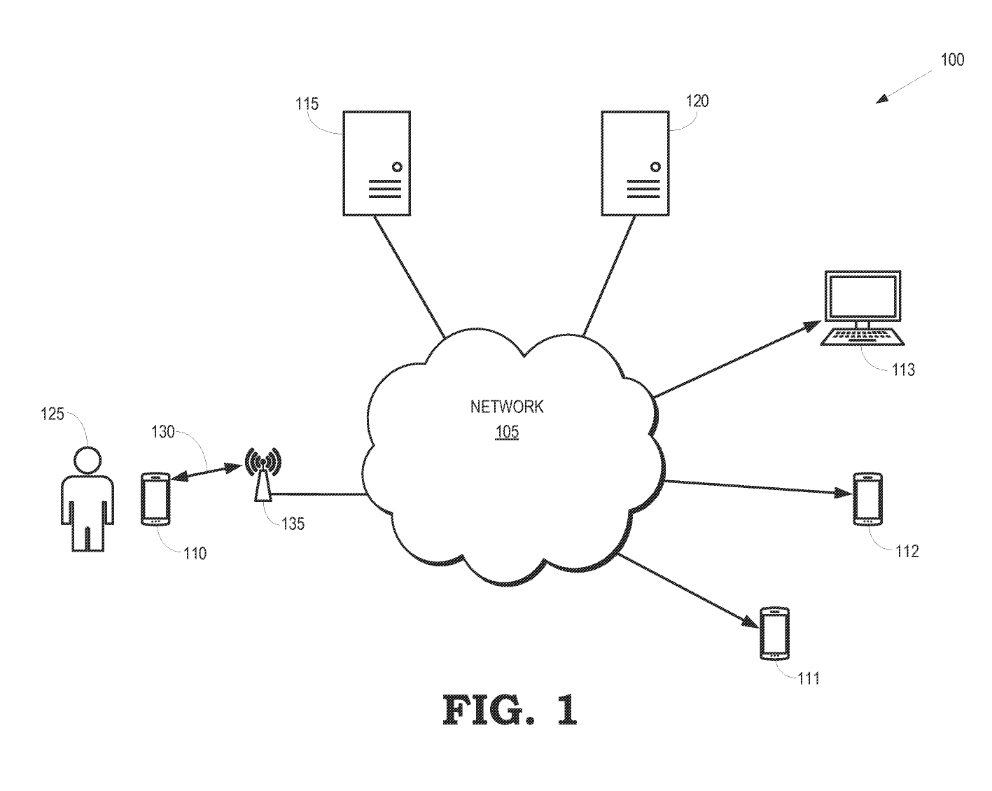

FIG. 1 is a diagram of an example of a communication system 100 according to some embodiments. The communication system 100 includes a network 105 and some embodiments of the network 105 may be implemented as a wired communication network, a wireless communication network, or a combination thereof. The network 105 supports communication between user equipment 110, 111, 112, 113 (referred to collectively as “the user equipment 110-113”), servers 115, 120, and other entities that are not depicted in FIG. 1 in the interest of clarity. For example, user 125 may interact with user equipment 110 to generate a message that is transmitted over an air interface 130 to a base station 135 that is connected to the network 105. The message may include text, images, or other information and the message may be transmitted from the base station 135 over the network 105 to the server 120. The server 120 may then distribute copies of some or all of the information in the message to one or more of the user equipment 111-113 via the network 105. Although the servers 115, 120 are depicted as single entities in FIG. 1, some embodiments of the servers 115, 120 may be implemented as distributed servers deployed at different locations and connected by appropriate networking infrastructure.

Some embodiments of the server 120 may be used to support social networking applications such as Facebook, LinkedIn, Google+, Twitter, and the like. The server 120 may therefore receive textual information included in posts or tweets from one or more of the user equipment 110-113 and then distribute the post or tweets to the other user equipment 110-113. For example, the user equipment 111-113 may be registered as “followers” of the user 125 associated with the user equipment 110. Each time the user 125 sends a tweet from the user equipment 110, the server 120 stores the tweet and forwards copies of the tweet to the user equipment 111-113. The post or tweets supported by different social networking applications may be constrained to particular sizes, such as a tweet that is limited to a string of up to 140 characters. Social networking applications may generate vast amounts of information. For example, as discussed herein, hundreds of millions of Twitter users produce millions of tweets every second. These applications may therefore be referred to as “big data” applications.

The value of the information produced by big data applications such as social networking applications may be significantly enhanced by organizing or classifying the data. The server 115 may therefore be configured to interact with the user equipment 110-113 and the server 120 to identify a set of classes based on blocks of text (such as messages, posts, or tweets) transmitted over the network 105 and then to classify the blocks of text into the classes in the set.

Identification of the set of classes can be performed efficiently by taking advantage of the sparse nature of the information in the blocks of text. As used herein, the term “sparse” is used to indicate that a signal of interest (such as a sequence of characters in the block of text) can be reconstructed from a finite number of elements of an appropriate sparsifying basis in a corresponding transform domain. More specifically, for a dataset that includes i=1, 2, . . . , M text blocks in each of n=1, 2, . . . , N timeslots, let x represent the signal of interest in the space R^{N} and let Ψ represent a sparsifying basis. The dataset x is K-sparse in Ψ if the signal of interest is exactly or approximately represented by K elements of the sparsifying basis Ψ. The dataset may therefore be reconstructed from M=rK<<N non-adaptive linear projections onto a second measurement basis Φ that is incoherent with the sparsifying basis Ψ. The over-measuring factor r is a small value that satisfies r>1. Two bases are incoherent if the elements of the first basis are not represented sparsely by the elements of the second basis and vice versa.

Some embodiments of the server 115 may compute a sparsifying matrix from a set of reference blocks that is selected from a training set of text blocks based on joint complexities of each pair of the text blocks in the training set. The joint complexity of a pair of text blocks is defined as the cardinality of a set of all distinct factors that are common in the suffix trees that represent the two text blocks in the pair, as discussed herein. The server 115 may acquire the training set from the server 120. The set of reference blocks includes the text blocks that have the highest overall joint complexity. The server may then receive one or measurement vectors from one or more of the user equipment 110-113. The measurement vectors are formed by compressing text blocks using a measurement matrix such as the measurement matrix Φ. The server 115 may then identify one of the set of reference blocks that is most similar to the subsequent text block based on the sparsifying matrix Ψ, the measurement matrix Φ, and the measurement vector corresponding to the subsequent text block. The subsequent text block may then be classified in the class associated with the identified one of the set of reference blocks. Some embodiments of the first server 115 may transmit a signal representative of the one of the set of reference blocks to indicate the classification of the text blocks, e.g., the signal may be transmitted to one or more of the user equipment 110-113.

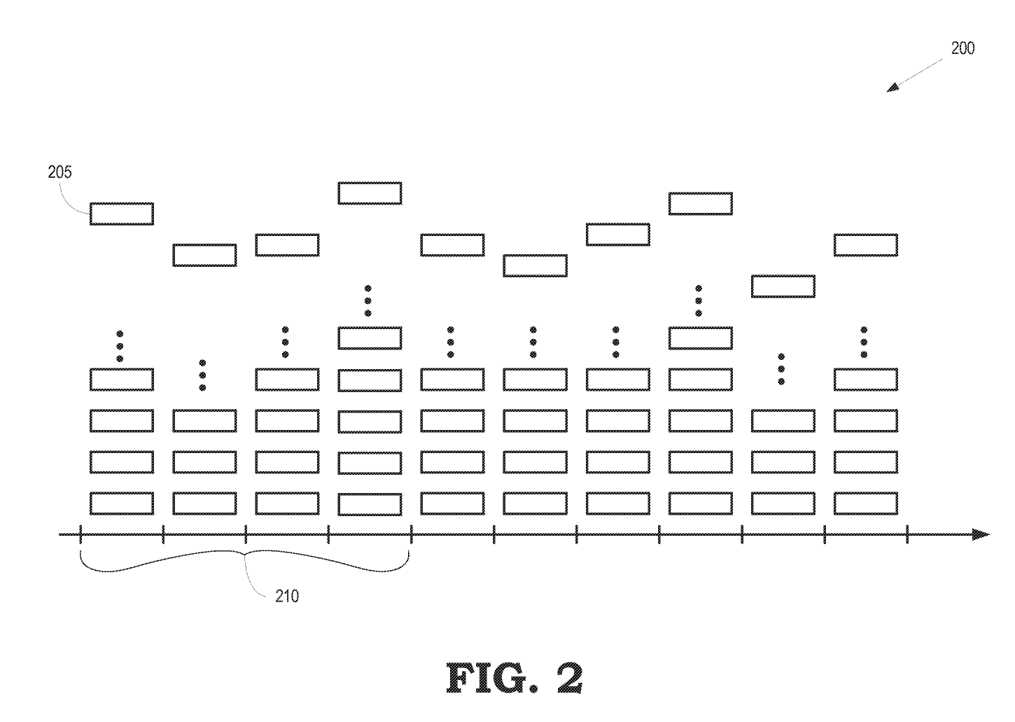

FIG. 2 is a block diagram illustrating a dataset 200 of text blocks 205 in different time intervals according to some embodiments. The horizontal axis indicates time increasing from left to right and the text blocks 205 (only one indicated by a reference numeral in the interest of clarity) in each time interval are arranged vertically. The number of text blocks 205 may be different in each time interval as illustrated in FIG. 2. A subset 210 of the dataset may be used as a training data set for selecting a set of reference blocks and defining a sparsifying basis, as discussed herein. The reference blocks and the sparsifying basis may then be used to classify subsequent text blocks 205. The sequence characters in each text block may be decomposed (in linear or sub-linear time) into a memory efficient structure called a suffix tree. The joint complexity of a pair of text blocks 205 may then be determined by overlapping the two suffix trees that represent the pair of text blocks 205. The overlapping operation may be performed in linear or sub-linear average time.

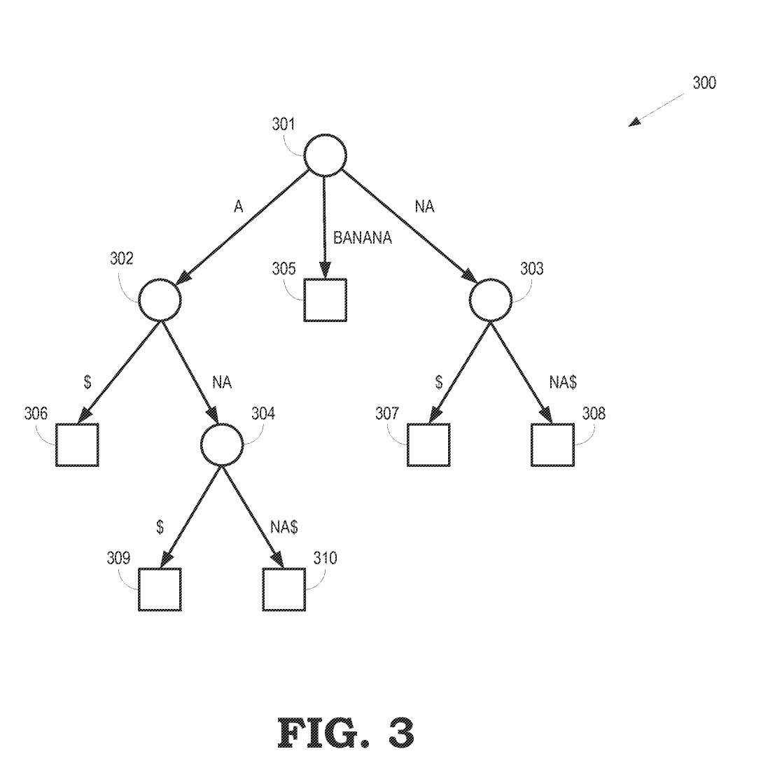

FIG. 3 is a diagram of a suffix tree 300 for a text block according to some embodiments. The suffix tree 300 is formed for a text block including the character string “banana” and includes nodes 301, 302, 303, 304 (collectively referred to as “the nodes 301-304”) and leaves 305, 306, 307, 308, 309, 310 (collectively referred to as “the leaves 305-310”) that are connected by corresponding edges. As used herein, the term “suffix tree” refers to a tree data structure that has n leaves numbered from 1 to n and, except for the root 301, every internal node 302-304 has at least two children. Each edge of the suffix tree 300 is labeled with a non-empty substring of the character string and no two edges starting out of a node 301-304 can have string labels beginning with the same character. The string obtained by concatenating all the string labels found on the path from the root 301 to a leaf 305-310 indicated by the index i spells out a suffix S[1 . . . n] for i=1 to n. In the illustrated embodiment each substring is terminated with a special character “5” and the paths from the root 301 to each leaf 305-310 correspond to six suffixes: “A$,” “NA$,” “ANA$,” “NANA$,” “ANANA$,” and “BANANA$.” Building the suffix tree for a text block of m characters costs O(m log m) operations and takes O(m) space in memory.

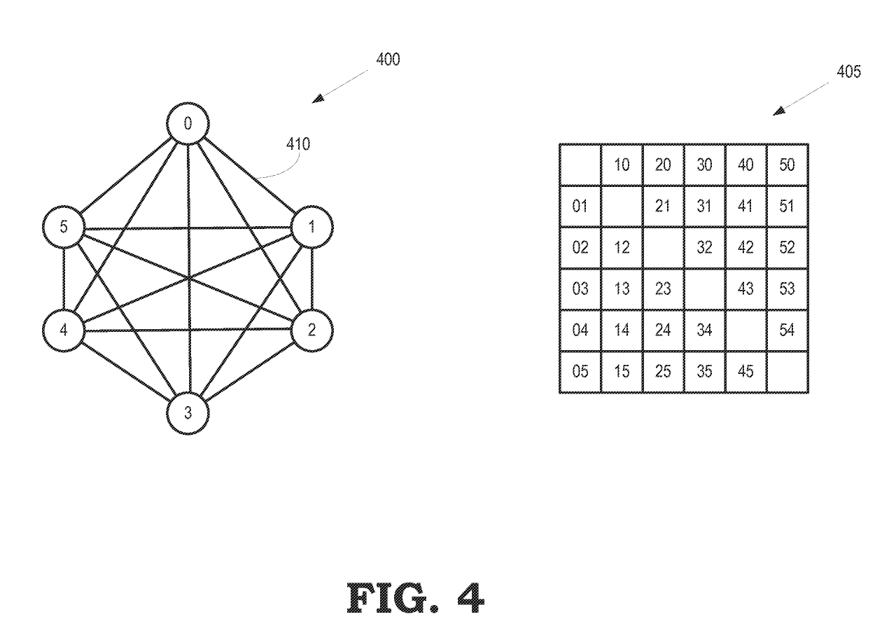

FIG. 4 is a diagram of a fully-connected graph 400 representing text blocks in a time interval and a matrix 405 of edge weights within the graph 400 according to some embodiments. The graph 400 includes six nodes (numbered 0-5) that represent six corresponding text blocks in the time interval. Connections between the nodes of the graph are represented by the edges 410 (only one indicated by a reference numeral in the interest of clarity). Each of the edges 410 is weighted by a value corresponding to the joint complexity of the pair of text blocks corresponding to the pair of nodes that are connected by each edge 410. Values of the joint complexities may then be stored in corresponding entries in the matrix 405. For example, the joint complexity of the nodes 0 and 1 are stored in the entries 01 and 10 of the matrix 405. In some embodiments, the symmetry of the matrix 405 may be used to reduce the representation of the matrix 405 to the upper triangular portion or lower triangular portion of the matrix 405.

A score may be computed for each node by summing weights of all the edges that are connected to that node. The node with the highest score may be considered the most representative or central text block of the time slot and may be used as a reference text block, as discussed herein. A graph 400 and a corresponding matrix 405 may be computed for the text blocks in each time interval in a sequence of time intervals. The most representative nodes of each time interval may then be calculated based on the graph 400 and matrix 405 for that time interval.

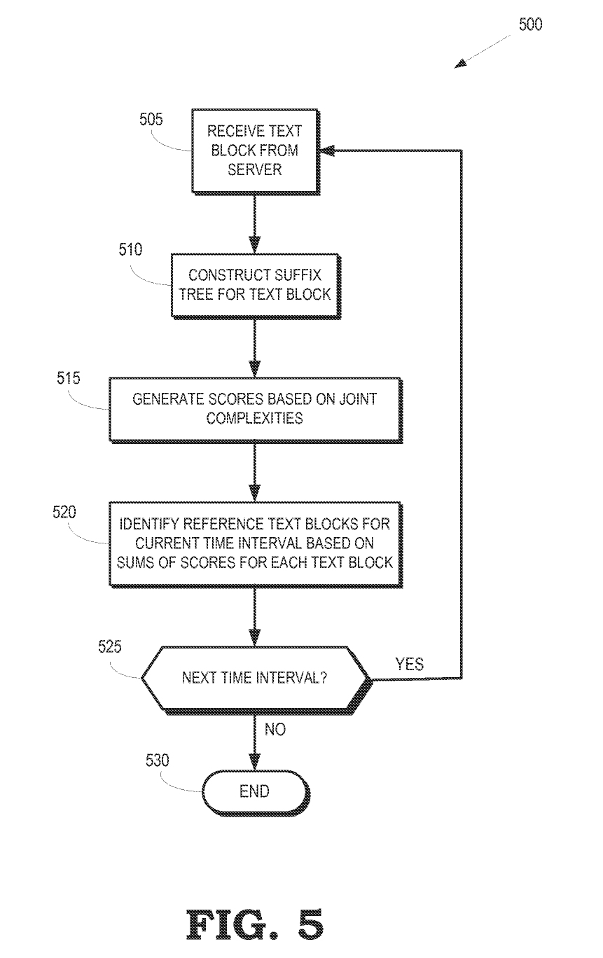

FIG. 5 is a flow diagram of a method 500 for identifying a set of reference text blocks that indicate corresponding classes according to some embodiments. The method 500 is discussed in the context of classifying tweets provided by a Twitter server but other embodiments of the method 500 may be used to classify other types of text blocks. At block 505, a server such as the server 115 shown in FIG. 1 receives a set of text blocks that can be used as a training data set. Some embodiments of the server 115 may request the data set from another server such as the server 120 shown in FIG. 1. For example, the server 115 may request a dataset of tweets from a Twitter server. The request may include filters for specific keywords such as politics, economics, sports, technology, lifestyle, and the like so that the Twitter server returns sets of tweets corresponding to the keywords. The tweets may be received in the .json format used by the Twitter Streaming API. The keywords may correspond to classes used for classification of subsequent tweets.

At block 510, the server constructs a suffix tree for each text block in the training data set. At block 515, the server determines scores for each of the text blocks based on the joint complexities for each pair of text blocks, as discussed herein. At block 520, the server identifies one or more reference text blocks for the current time interval based on the sums of the scores for each text block. For example, a text block may be selected as a reference text block if he has the highest score among the text blocks for the current time interval or if the score for the text block is above a threshold. At decision block 525, the server determines whether there are text blocks for additional time intervals. If so, the method 500 is iterated and reference text blocks are selected for the subsequent time intervals. Otherwise, the method 500 ends at block 530.

The set of reference text blocks determined by the method 500 shown in FIG. 5 may be used to classify subsequent text blocks using compressive sensing. In some embodiments, the signal of interest such as a text block represented by x may be compressed by projecting the text block x into a measurement domain using a measurement matrix Φ that is defined in the space R^{MN}. For example, a measurement vector g may be defined in the space R^{M} as:

g=Φ·x.

The measurement vector g is compressed relative to the text block x and consequently contains less information than the text block x. The text block x may also be expressed in terms of the sparsifying basis Ψ as:

x=Ψ·w,

where w is a vector of transform coefficients in the space R^{D}. Consequently, the measurement vector g has the following equivalent transform-domain representation:

g=Φ·Ψ·w

The measurement matrix Φ is, with high probability due to the universality property, incoherent with the fixed transform basis Ψ. The measurement matrix Φ may also be a random matrix with independent and identically distributed (i.i.d.) Gaussian or Bernoulli entries.

Each text block x is to be placed in one of a set of C non-overlapping classes and so the classification problem is inherently sparse. For example, if

w=[0 0 . . . 0 1 0 0 . . . O]^{T}

is a class indicator vector in the space R^{C} that is defined so that the j-th component of w is equal to “1” if the text block x is classified in the j-th class, the problem of classifying the text block x is reduced to a problem of recovering the one-sparse vector w corresponding to the text block x. In some embodiments, the sparsity of the problem may not be exact and the estimated class of the text block x may correspond to the largest amplitude component of w.

Due to the K-sparsity property in the basis Ψ, the sparse vector w and the original signal represented by the text block x may be recovered with high probability by employing M compressive measurements for the M text blocks. In one embodiment, the measurement matrix Φ may correspond to noiseless compressive sensing measurements. The sparse vector w may then be estimated by solving a constrained L⁰ optimization problem using the objective function:

\tilde{w}>=argmin{w}∥w∥₀ such that g=Φ·Ψ·w (1)

where ∥w∥₀ denotes the L⁰ norm of the vector w, which is defined as the number of non-zero components of the vector w. In another embodiment, the problem is an NP complete problem and so the sparse vector w may be estimated by a relaxation process that replaces the L⁰ norm with the L¹ norm in the objective function:

\tilde{w}>=argmin{w}∥w∥₁ such that g=Φ·Ψ·w (2)

where ∥w∥₁ denotes the L¹ norm of the vector w. The optimization problem defined by equation (2) may recover the sparse vector w using M≳K log D compressive sensing measurements. The optimization problems defined by equations (1) and (2) may be equivalent when the matrices Ψ and Φ satisfy the restricted isometry property. In another embodiment, the objective function and the constraint from equation (2) may be combined into a single objective function:

\tilde{w}>=argmin{w}∥w∥₁+τ·∥g=Φ·Ψ·w∥₂ (3)

where τ is a regularization factor that controls a trade-off between the achieved sparsity and the reconstruction error. Equations (1-3) may be solved using known algorithms. For example, equation (3) may be solved using linear programming algorithms, convex relaxation, or greedy strategies such as orthogonal matching pursuit.

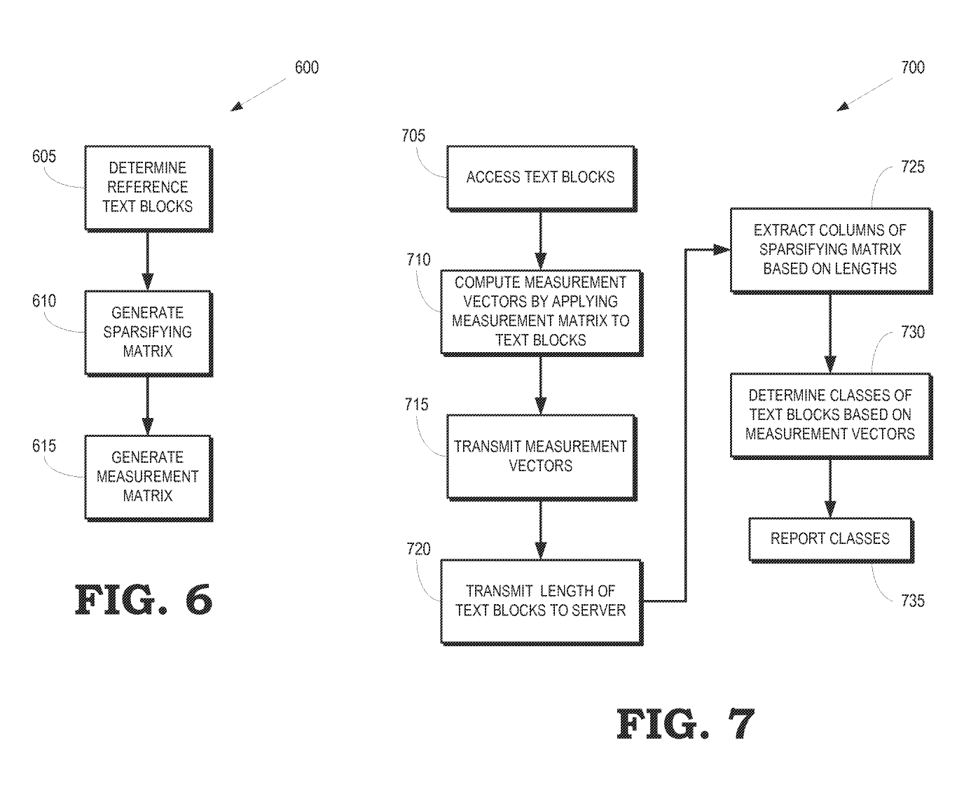

FIG. 6 is a flow diagram of a method 600 for a pre-processing phase of classification of text blocks by compressive sensing according to some embodiments. The method 600 may be implemented in some embodiments of the server 115 shown in FIG. 1. At block 605, the server determines one or more reference text blocks based on a training data set such as a training data set acquired from the server 120 shown in FIG. 1. The server may determine the reference text blocks using embodiments of the method 500 shown in FIG. 5.

At block 610, the server determines a sparsifying matrix based upon the reference text blocks. For example, the server may form a vector x_{j,T}ⁱ of character strings from the text blocks that are to be classified in one of a set (C) of classes indicated by the index j. The vector x_{j,T}ⁱ is in the space Rⁿ^{_{i,j}}, where n_{j,i}≠n_{j′,i′}, if j≠j′ and i≠i′. The vectors x_{j,T}ⁱ are generated for the set (C) of classes corresponding to the reference text blocks by the server, which may then form a single matrix Ψ_{T}ⁱ in the space R^{N}^{ᵢ}^{×C} for the i-th reference text block by concatenating the corresponding C vectors. The matrix Ψ_{T}ⁱ may then be used as the sparsifying matrix or sparsifying dictionary for the i-th reference text block. In some embodiments, the vector of reference text blocks for a given class j received from the reference text block indicated by the index i can be closer to the corresponding vectors of its neighboring classes. The sparsifying matrix Ψ_{T}ⁱ may then be expressed as a linear combination of a subset of the columns of the matrix Ψ_{T}ⁱ.

At block 615, the server determines a measurement matrix Ψ_{T}ⁱ in the space R^{M}^{ᵢ}^{×N}^{ᵢ}. The value Mᵢ indicates the number of compressive sensing measurement vectors generated from corresponding reference text blocks. The measurement matrix Ψ_{T}ⁱ is associated with the sparsifying matrix Ψ_{T}ⁱ. Some embodiments of the measurement matrix Ψ_{T}ⁱ are Gaussian measurement matrices or Bernoulli measurement matrices that are known in the art. The measurement matrix Ψ_{T}ⁱ may have its columns normalized to unit L² norm.

FIG. 7 is a flow diagram of a method 700 for a runtime phase of classification of text blocks by compressive sensing according to some embodiments. The method 700 may be implemented in some embodiments of the user equipment 110-113 or the servers 115, 120 shown in FIG. 1. At block 705, the text blocks that are to be classified or accessed. In some embodiments, user equipment accesses text blocks generated by the user equipment or received by the user equipment. The text blocks that are going to be classified maybe represented by the vector x_{c,R}ⁱ (in the space Rⁿ^{_{c,i}}) of the text blocks that are to be classified at the (unknown at this point in the method 700) class c from the i-th reference text block.

At block 710, the user equipment generates measurement vectors g_{c,i} for compressive sensing by applying the measurement model associated with the class c and the i-th reference text block:

g_{c,i}=Φ_{R}_{ⁱ}·x_{c,R}ⁱ (4)

where Ψ_{R}_{ⁱ} defined in the space R^{M}^{_{c,i}}^{×N}^{_{c,i}} denotes the corresponding measurement matrix use during the run phase. The measurement vectors g_{c,i} are compressed relative to the vector x_{c,R}ⁱ and consequently contain less information. At block 715, the user equipment transmits information representative of the measurement vectors g_{c,i} to the server.

In some embodiments, a difference in dimensionality may exist between the measurement or sparsifying matrix defined in the pre-processing phase (e.g., in the method 600 shown in FIG. 6) and the measurement or sparsifying matrix is used in the run phase depicted in FIG. 7. The robustness of the reconstruction procedure may be maintained by transmitting (at 720) an indication of the length of the text blocks to be classified from the user equipment to the server. The length may then be used to extract (at 725) a subset of the columns of the sparsifying matrix for the runtime phase. For example, the sparsifying matrix Ψ_{R}_{ⁱ} for the runtime phase may be formed from a subset of the columns of the sparsifying matrix Ψ_{T}ⁱ that was determined during the pre-processing phase.

At block 725, the server determines classes of the text blocks based on the corresponding measurement vectors received from the user equipment. For example, the server may optimize the objective function represented by equation (3) to determine the values of the corresponding classification vector w for each of the measurement vectors g_{c,i}. The sparsifying matrix Ψ_{T}ⁱ may be used as the appropriate sparsifying dictionary. At block 730, the server may transmit information indicating the classifications of the vectors x_{c,R}ⁱ to the user equipment. In some embodiments, the server may delete text blocks based upon their page. For example, the server may delete text blocks that are older than a given time so that the text classification procedure is performed based on more recent text blocks.

Embodiments of the method 700 may conserve the processing and bandwidth resources of the user equipment by computing only the relatively low-dimensional matrix vector products to form the measurement vectors g_{c,i}. For example, the amount of data transmitted from the user equipment to the server is reduced approximately by the ratio of M_{c,1} to N_{c,i}, where M_{c,i}<<N_{c,i}. Thus, embodiments of the method 700 for compressive sensing reconstruction and classification of text blocks may be performed remotely (e.g., at the server, for text blocks applied by user equipment) and independently for each reference text block.

Text blocks may be associated with a characteristic or parameter and a filtering process may be used to generate a tracking model that can be used to predict classes of text blocks generated or received at subsequent times. For example, the text blocks associated with a particular user may be used to generate a tracking model based on Kalman filtering. Some embodiments of algorithms that create and update the prediction model using Kalman filtering can be executed in real time because they are based on currently available information and one or previously estimated classifications of the text block. For example, text blocks associated with the user can be classified at a time t into a class that is represented by:

p*(t)=[w*(t)]^{T}

where w is a class indicator vector and T represents the transpose operation. The process noise and the observation noise may be assumed to be Gaussian and a linear motion dynamics model for the class may be used. The process and observation equations for a tracking model of the class indicator vector w that is generated based on a Kalman filter may be represented as:

w(t)=F·w(t−1)+θ(t) (5)

z(t)=H·w(t)+ν(t) (6)

where w(t)=[w(t), u_{w}(t)]^{T} is the state vector, w(t) is the class in the space defined by the text blocks, u_{w}(t) as the frequency of generation or reception of text blocks, and z(t) is the observation factor for the Kalman filter. The motion matrices F and H are defined by a linear motion model and standard motion matrices F and H are known in the art. The process noise θ(t)˜N (0, S) and the observation noise ν(t)˜N (0, U) are independent zero-mean Gaussian vectors with covariance matrices S and U, respectively. The current class of the user may be assumed to be the previous class plus a joint complexity distance metric that is computed by multiplying a time interval by the current speed or frequency at which text blocks are generated.

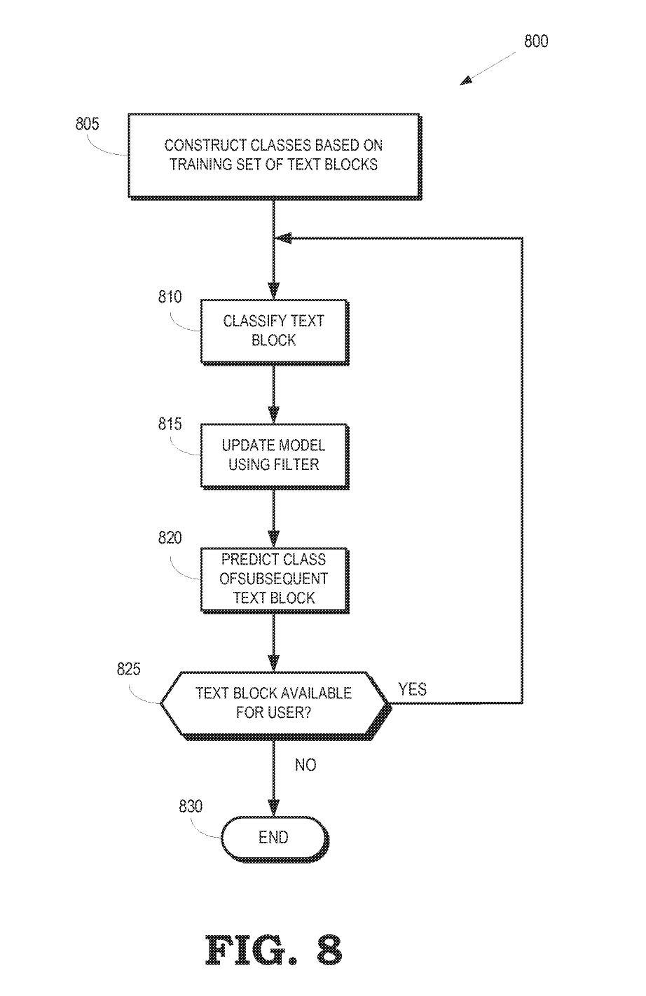

FIG. 8 is a flow diagram of a method 800 for generating a tracking model and predicting classes of text blocks according to some embodiments. The method 800 may be implemented in some embodiments of the server 115 shown in FIG. 1. The illustrated embodiment of the method 800 generates a tracking model for text blocks such as tweets associated with the user. However, as discussed herein, some embodiments of the method 800 may be used to generate a tracking model and predict classes of text blocks that are grouped according to any characteristic or parameter. At block 805, the server constructs a set of classes based on a training set of text blocks, e.g., using embodiments of the method 500 shown in FIG. 5. At block 810, the server classifies a text block associated with the user, e.g., using embodiments of the method 600 shown in FIG. 6 or the method 700 shown in FIG. 7.

At block 815, the server updates the tracking model associated with the user based on a filter such as a Kalman filter. Some embodiments of the server can update the tracking model by updating a current estimate of a state vector w*(t) that indicates the current estimated class of the text block and the error covariance P(t) for the state vector. For example, the server may update the state vector w*(t) and its corresponding error covariance P(t) using the equations:

w*⁻(t)=F·w*(t−1) (7)

P⁻(t)=F·P(t−1)·F^{T}+S (8)

K(t)=P⁻(t)·H^{T}·(H·P⁻(t)·H^{T}+U)⁻¹ (9)

w*(t)=w*⁻(t)+K(t)·(z(t)−H·w*⁻(t)) (10)

P(t)=(I−K(t)·H)·P⁻(t) (11)

where the superscript “−” denotes the prediction at time t and K(t) is the optimal Kalman filter gain at time t. At block 820, the server may predict the class of a subsequent text block for the user at a time t using the tracking model, e.g., equation 10. At decision block 825, the server determines whether a new text block is available for the user. If so, the method 800 is iterated and the model is updated based on the new text block. Otherwise, the method ends at block 830.

Embodiments of the method 800 may exploit the highly reduced set of compressed measurement vectors produced from the original text blocks and previous information regarding the class of the user to restrict the set of candidate training regions based on physical proximity in the space defined by the reference text blocks. Applying the Kalman filter in the classification system based on compressive sensing may also improve the classification accuracy of the “path” of the text blocks associated with the user. In practice, the class indicator vectors w* may not be perfectly sparse and thus the estimated class (x_{CS} or equivalently the class c_{CS}) for a text block may correspond to the highest amplitude index of the class indicator vector w*. This estimate may be provided as an input to the Kalman filter by assuming the estimate corresponds to the previous time (t−1) so that:

x*(t−1)=[x_{CS},uₓ(t−1)]^{T}

and the current class may be updated using equation (7). Some embodiments of the method 800 may use the low-dimensional set of compressed measurements given by equation (3), which may be obtained using a simple matrix-vector multiplication with the original high dimensional vector. Some embodiments of the method 800 may therefore conserve the limited memory and bandwidth capabilities of mobile devices while also performing accurate information tracking and potentially increasing the lifetime of the mobile device.

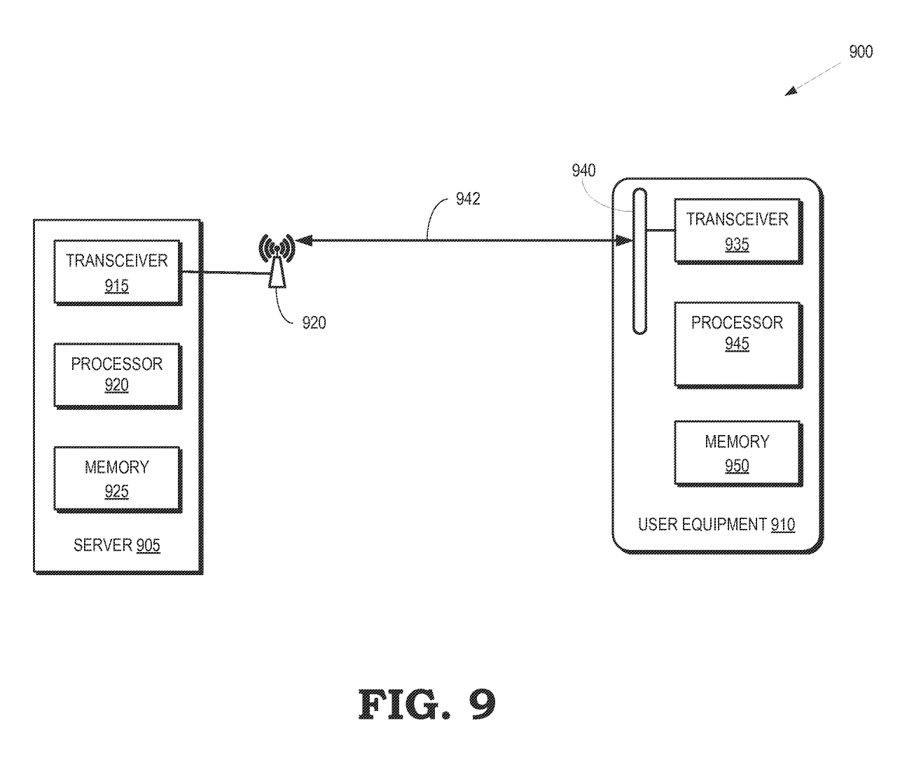

FIG. 9 is a block diagram of an example of a communication system 900 according to some embodiments. The communication system 900 includes a server 905 and user equipment 910. Some embodiments of server 905 may be used to implement the server 115 shown in FIG. 1. Some embodiments of the user equipment 910 may be used to implement the user equipment 110-114 shown in FIG. 1.

The server 905 includes a transceiver 915 for transmitting and receiving signals. The signals may be wired communication signals or wireless communication signals received from a base station 920. The transceiver 915 may therefore operate according to wired or wireless communication standards or protocols. The server 905 also includes a processor 925 and a memory 930. The processor 925 may be used to execute instructions stored in the memory 930 and to store information in the memory 930 such as the results of the executed instructions. Some embodiments of the processor 925 and the memory 930 may be configured to perform portions of the method 500 shown in FIG. 5, the method 600 shown in FIG. 6, the method 700 shown in FIG. 7, or the method 800 shown in FIG. 8.

The user equipment 910 includes a transceiver 935 for transmitting and receiving signals via antenna 940. The transceiver 935 may therefore operate according to wireless indication standards or protocols. The user equipment 910 and the server 905 may therefore communicate over an air interface 942. The user equipment 910 also includes a processor 945 and a memory 950. The processor 945 may be used to execute instructions stored in the memory 950 and to store information in the memory 950 such as the results of the executed instructions. Some embodiments of the processor 945 and the memory 950 may be configured to perform portions of the method 500 shown in FIG. 5, the method 600 shown in FIG. 6, the method 700 shown in FIG. 7, or the method 800 shown in FIG. 8.

Some embodiments of text classification according to joint complexity and compressive sensing may have a number of advantages over the conventional practice. For example, text classification can be performed without human intervention. The text classification is context free, requires no grammar, doesn't make any language assumptions, and does not use semantics to process the text blocks. The reference text blocks discussed herein include the algorithmic signature of the text, which can be used to perform a fast and massively parallel similarity detection between the text blocks. Similarities can be detected between texts in any loosely character-based language because embodiments of the techniques described herein are language agnostic. Consequently, there is no need to build a specific dictionary or implement a stemming method. Classification based on compressive sensing is more efficient than the conventional practice because a comparison is performed with a limited number of reference text blocks instead of comparing to a database. In some cases only 20% of the measurement vectors may be used for the comparison. Kalman filtering of the text classes may also be used to track information within the work. Updating of the database ensures the diversity of new topics or classes that are selected by the joint complexity method.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
computing, at a first server, a sparsifying matrix from a set of reference blocks that is selected from first blocks of text based on joint complexities of each pair of the first blocks of text;
determining, at the first server, one of the set of reference blocks that is most similar to a second block of text based on the sparsifying matrix, a measurement matrix, and a measurement vector formed by compressing the second block of text using the measurement matrix; and
transmitting, from the first server, a signal representative of the one of the set of reference blocks to indicate a classification of the second block of text.

2. The method of claim 1, further comprising:
requesting the first blocks of text from a second server, wherein the first blocks of text are associated with a plurality of classes used for the classification of the second block of text.

3. The method of claim 1, further comprising:
generating suffix trees representative of the first blocks of text; and
computing the joint complexities of each pair of the first blocks of text as a cardinality of a set of factors that are common to pairs of suffix trees that represent each pair of the first blocks of text.

4. The method of claim 1, further comprising:
generating a fully-connected edge-weighted graph including nodes corresponding to the first blocks of text, wherein the weights of edges of the graph are determined by the joint complexities of a pair of first blocks of text corresponding to the nodes connected by the edge; and
selecting the set of reference blocks from the first blocks of text that have the highest sums of weights of edges connected to the corresponding nodes.

5. The method of claim 1, wherein determining the one of the set of reference blocks that is most similar to the second block of text comprises determining a vector representative of the second block of text in a transform domain associated with the sparsifying matrix by optimizing an objective function of the sparsifying matrix, the measurement matrix, and the measurement vector formed by compressing the second block of text using the measurement matrix.

6. The method of claim 1, further comprising:
receiving the measurement vector from user equipment that formed the measurement vector using the measurement matrix and the second block of text stored by the user equipment, and wherein transmitting the signal representative of the one of the set of reference blocks comprises transmitting a signal from the server to the user equipment.

7. The method of claim 1, further comprising:
predicting a classification of a third block of text based on the classification of the second block of text by applying a Kalman filter to the classification of the second block of text.

8. The method of claim 1, wherein the first blocks of text and the second block of text are strings of up to 140 characters.

9. An apparatus comprising:
a processor to compute a sparsifying matrix from a set of reference blocks that is selected from first blocks of text based on joint complexities of each pair of the first blocks of text and determine one of the set of reference blocks that is most similar to a second block of text based on the sparsifying matrix, a measurement matrix, and a measurement vector formed by compressing the second block of text using the measurement matrix; and
a transceiver to transmit a signal representative of the one of the set of reference blocks to indicate a classification of the second block of text.

10. The apparatus of claim 9, wherein the transceiver is to transmit a request for the first blocks of text to a second server, wherein the first blocks of text are associated with a plurality of classes used for the classification of the second block of text.

11. The apparatus of claim 9, wherein the processor is to generate suffix trees representative of the first blocks of text and compute the joint complexities of each pair of the first blocks of text as a cardinality of a set of factors that are common to pairs of suffix trees that represent each pair of the first blocks of text.

12. The apparatus of claim 9, wherein the processor is to generate a fully-connected edge-weighted graph including nodes corresponding to the first blocks of text, wherein the weights of edges of the graph are determined by the joint complexities of the pair of first blocks of text corresponding to the nodes connected by the edge, and wherein the processor is to select the set of reference blocks from the first blocks of text that have the highest sums of weights of edges connected to the corresponding nodes.

13. The apparatus of claim 9, wherein the processor is to determine a vector representative of the second block of text in a transform domain associated with the sparsifying matrix by optimizing an objective function of the sparsifying matrix, the measurement matrix, and the measurement vector formed by compressing the second block of text using the measurement matrix.

14. The apparatus of claim 9, wherein the transceiver is to receive the measurement vector from user equipment that formed the measurement vector using the measurement matrix and the second block of text stored by the user equipment, and wherein the transceiver is to transmit a signal to the user equipment.

15. The apparatus of claim 9, wherein the processor is to predict a classification of a third block of text based on the classification of the second block of text and update an estimate of the classification of the third block of text by applying a Kalman filter to the predicted classification of the third block of text.

16. The apparatus of claim 9, wherein the first blocks of text and the second blocks of text are strings of up to 140 characters.

17. An apparatus comprising:
a processor to form a measurement vector using a measurement matrix and a first block of text; and
a transceiver to transmit the measurement vector to a server and, in response, receive a signal representative of one of a set of reference blocks to indicate a classification of the first block of text, wherein the set of reference blocks is selected from second blocks of text based on joint complexities of each pair of the second blocks of text, and wherein the one of the set of reference blocks is determined to be most similar to the first block of text based on a sparsifying matrix determined based on the set of reference blocks, the measurement matrix, and the measurement vector.

18. The apparatus of claim 17, wherein the processor is to form the measurement vector by multiplying the measurement matrix and a character string of up to 140 characters.

19. The apparatus of claim 17, wherein the processor is to form the measurement vector so that the measurement vector is compressed relative to the first block of text.

20. The apparatus of claim 17, wherein the apparatus is a user equipment.
